(19) United States
(12) Patent Application Publication
(10) Pub. No.: US 2025/0287206 A1
(43) Pub. Date: Sep. 11, 2025

(54) DYNAMIC SECURITY PROTOCOL SELECTION IN A WIRELESS NETWORK

(71) Applicant: Charter Communications Operating, LLC, St. Louis, MO (US)

(72) Inventors: Nima Namvar, Charlotte, NC (US); Umamaheswar A. Kakinada, Greenwood Vilage, CO (US); Imtiyaz Shaikh, Irving, CA (US); Dumitru M. lonescu, Poway, CA (US); Maulik V. Vaidya, Escondido, CA (US)

(21) Appl. No.: 18/599,577

(22) Filed: Mar. 8, 2024

(51) Int. Cl. H04W 12/08; H04W 12/73; H04W 76/10

(52) U.S. Cl. CPC H04W 12/08; H04W 12/73; H04W 76/10

(57) ABSTRACT

A wireless communication system includes a first wireless station and a second wireless station. The communication management resource associated with the first wireless station can be configured to: retrieve first protocol information assigned to the first wireless station, the first protocol information indicating a first wireless security protocol supported by the first wireless station; transmit a notification to a second wireless station indicating the first wireless security protocol supported by the first wireless station; and select a wireless security protocol in which to communicate with the second wireless station based on the first protocol information and second protocol information received from the second wireless station.

### BACKGROUND

Wi-Fi™ technology implements security communication protocols such as WPA2 and WPA3.

Wi-Fi Protected Access 2 (a.k.a., WPA2) employs Advanced Encryption Standard (AES) to ensure a robust and secure network. The cornerstone of WPA2's security lies in the Pre-Shared Key (PSK) mechanism, where users authenticate themselves through a passphrase, initiating a key derivation process that culminates in the establishment of a secure connection.

In a subsequent iteration, WPA3 (Wi-Fi Protected Access 3) introduces individualized data encryption, elevating the level of security in Wi-Fi™ networks. WPA3 pioneers the Simultaneous Authentication of Equals (SAE) to foster more secure network by mitigating offline dictionary attack and bolstering the overall authentication process.

The PSK mechanism in WPA2 involves users entering a passphrase, initiating a secure key derivation process. This derived key is then employed for authentication, forming the foundation of the connection's security. While effective, PSK is not without its vulnerabilities, particularly when weak passphrases could be exploited through brute-force attack. The KRACK (such as so-called Key reinstallation attacks) and dictionary-based attacks are known to compromise WPA2 under some conditions.

SAE in WPA3 represents a paradigm shift in authentication. Both communicating parties contribute to the creation of a shared key, providing a more resilient mechanism. SAE is particularly designed to thwart the offline dictionary attack.

There has been a transition from WPA2 to WPA3. For example, the Wi-Fi™ Alliance replaced WPA2 with WPA3, offering a 128-bit encryption in WPA3-Personal mode and 192-bit in WPA3 Enterprise mode and introduced SAE as the authentication mechanism.

WPA3-TM is intended to facilitate coexistence of legacy and new WIFI-7 devices simultaneously in the network by supporting WPA2 and WPA3. The coexistence of WPA2 and WPA3 may impact some legacy devices by preventing them from connecting to a respective network.

### BRIEF DESCRIPTION OF EXAMPLES

This disclosure includes the observation that used Legacy wireless communication devices are not able to infer the WPA2 support from conventional received messages. Such devices therefore do not attempt to initiate the authentication process. This may result in loss of connectivity for legacy devices to the respective network.

In contrast to the conventional implementations, techniques herein include a Dynamic Security Protocol Selection (DSPS) for device compatibility.

The essence of the novel protocol selection technique as described herein includes one or more operation such as:
During active/passive scanning, the AP (access point) “infers” device capabilities
The inference is either based on the provided information during the frame exchange, or is a result of direct inquiry by the AP (i.e., wireless base station or wireless access point) and/or STA (wireless station such as mobile communication device).
The AP confirms capabilities with the STAs, allowing tailored measures for network connection.
AP enables flexible security and authentication protocols based on device capability

Techniques herein promote efficiency to ensure seamless connectivity while accommodating diverse device capabilities in different frequency bands. These techniques are not only applicable to current bands, APs, and legacy devices device. This helps build compatibility for future bands as well. Also, between newer APs and legacy devices as well newer devices and legacy APs in the future.

As further discussed herein, this disclosure includes multiple techniques to provide better use of wireless services supporting updated one or more wireless security communication protocols (a.k.a., wireless security protocols) supporting secured conveyance of data between wireless stations such as a wireless access point and a corresponding mobile communication device (a.k.a., user equipment).

More specifically, the wireless system as discussed herein can be configured to include any number of wireless stations such as a first wireless station (such as a mobile communication device or other suitable entity) and a second wireless station (such as a wireless base station, wireless access point, or other suitable entity). In one example, the first wireless station: retrieves first protocol information assigned to the first wireless station, the first protocol information indicating a first wireless security protocol supported by the first wireless station; transmits a notification to a second wireless station indicating the first wireless security protocol supported by the first wireless station; and selects a wireless security protocol in which to communicate with the second wireless station based on the first protocol information (assigned one or more wireless security protocols or a level i associated with a supported wireless security protocol) and second protocol information (such as an assigned one or more wireless security protocols or a level j associated with a supported wireless security protocol) received from the second wireless station.

In accordance with further examples as discussed herein, the second protocol information can be configured to indicate the first wireless security protocol; the notification may be a probe request transmitted by the first wireless station to learn of an identity of a wireless network supported by the second wireless station. The selected wireless security protocol may be the first wireless security protocol for another wireless security protocol. In response to selection of the first wireless security protocol, the first wireless station establishes a respective wireless communication link between the first wireless station and the second wireless station using the selected first wireless security protocol.

In accordance with another example as discussed herein, the first wireless station can be configured to receive the second protocol information from the second wireless station in response to transmitting the notification as previously discussed. The second protocol information can be configured to indicate a second wireless security protocol different than the first wireless security protocol. Assume that the selected wireless security protocol is the second wireless security protocol. In response to selection of the second wireless security protocol, the first wireless station establishes a respective wireless communication link between the first wireless station and the second wireless station using the second wireless security protocol.

Yet further, in one example, the second protocol information indicates identities of multiple wireless security protocols supported by the second wireless station. The identities of the multiple wireless security protocols may indicate the first wireless security protocol and a second wireless security protocol. The first wireless security protocol may correspond to a first level in a tiered hierarchy of multiple wireless security protocols. The second wireless security protocol may correspond to a second level in the tiered hierarchy of multiple wireless security protocols. In one example, the second level ranks higher than the first level in the tiered hierarchy.

In accordance with further examples as discussed herein, the selected wireless security protocol may be the first wireless security protocol or the second wireless security protocol.

In yet further examples, the first wireless station can be configured to, prior to transmitting the notification as previously discussed, receive a beacon frame from the second wireless station. The beacon frame may indicate one or more wireless security protocols in a hierarchy of protocols supported by the second wireless station.

Still further examples as discussed herein include the first wireless station receiving a message from the second wireless station prior to transmitting the notification. The message can be configured to indicate a second wireless communication protocol supported by the second wireless station. In one example, the first wireless station transmits the notification from the first wireless station to the second wireless station in response to detecting that the second wireless security protocol supported by the second wireless station is different than the first wireless security protocol supported by the first wireless station.

In accordance with still further examples as discussed, in response to transmitting the notification as previously discussed, the first wireless station may receive a message from the second wireless station indicating that the second wireless station supports the first wireless security protocol. Selection of the wireless security protocol may include: in response to detecting that the second wireless station supports the first wireless security protocol as indicated by the received message, establish a wireless communication link between the first wireless station and the second wireless station using the first wireless security protocol.

Another example herein includes the first wireless station receiving a communication from the second wireless station prior to transmitting the notification. The communication can be configured to indicate an identity of the second wireless station and a second wireless security protocol supported by the second wireless station.

Yet further, the second wireless station can be configured to transmit first beacons indicating that the second wireless station supports the first wireless security protocol. The second wireless station can be configured to transmit second beacons indicating that the second wireless station supports a second wireless security protocol. The second wireless security protocol may be different than the first wireless security protocol. In accordance with further examples, a ratio of a number of the transmitted first beacons with respect to a number of the transmitted second beacons transmitted by the second wireless station is based upon a number of first communication devices wirelessly connected to the second wireless station via the first wireless security protocol versus a number of second communication devices wirelessly connected to the second wireless station via the second wireless security protocol. Note further that the ratio as discussed herein may also be formulated based on combination of operator policy, time of days, special events (sports, conferences etc.).

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources. The instructions, when executed by computer processor hardware, cause the computer processor hardware (such as one or more co-located or disparately processor devices or hardware) to: retrieve first protocol information assigned to the first wireless station, the first protocol information indicating a first wireless security protocol supported by the first wireless station; transmit a notification to a second wireless station indicating the first wireless security protocol supported by the first wireless station; and select a wireless security protocol in which to communicate with the second wireless station based on the first protocol information and second protocol information received from the second wireless station.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless communication services. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and multiple wireless stations negotiating use of a wireless security protocol to communicate with each other in a wireless network environment as discussed herein.

FIG. 2 is an example diagram illustrating communication of wireless beacons for each of multiple different wireless security protocols associated with a first wireless network as discussed herein.

FIG. 3 is an example diagram illustrating a ratio of broadcasting different beacons for different wireless security protocols associated with the first wireless network as discussed herein.

FIG. 4 is an example diagram illustrating multiple beacons (such as informational messages) advertising support for different wireless security protocols supported by the first wireless network as discussed herein.

FIG. 5 is an example diagram illustrating communication of wireless beacons for each of multiple different wireless security protocols associated with a second wireless network as discussed herein.

FIG. 6 is an example diagram illustrating a ratio of broadcasting different beacons for different wireless security protocols associated with the second wireless network as discussed herein.

FIG. 7 is an example diagram illustrating multiple beacons advertising support for the different wireless security protocols associated with the second wireless network as discussed herein.

FIG. 8 is an example diagram illustrating implementation of operations by a mobile communication device to select a wireless security protocol as discussed herein.

FIG. 9 is an example diagram illustrating a network environment and multiple wireless stations negotiating use of a wireless security protocol to communicate with each other in a wireless network environment as discussed herein.

FIG. 10 is an example diagram illustrating implementation of operations by a mobile communication device to select a wireless security protocol as discussed herein.

FIG. 11 is an example diagram illustrating example computer architecture operable to execute one or more operations as discussed herein.

FIG. 12 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

As discussed herein, most Legacy devices do not support Multi BSSID.

The 802.11ax amendment has made Multi BSSID support mandatory for APs operating in the 6 GHz band because vendors can implement support for parsing the Multiple BSSID element in all the new 6 GHz clients.

A Multiple BSSID element may be used in the 2.4 or 5 GHz bands; nevertheless, legacy clients will not recognize the Multiple BSSID element unless their drivers are updated.

Techniques herein may include Dynamic Security Protocol Selection (DSPS) for device compatibility.

For example, as discussed herein, during active/passive scanning, the AP can be configured to infer device capabilities. The inference may be either based on the provided information during the frame exchange, or is a result of direct inquiry by the AP and/or STA. The AP confirms capabilities with the STAs, allowing tailored measures for network connection. AP enables flexible security and authentication protocols based on device capability.

The techniques as discussed herein promote efficiency to ensure seamless connectivity while accommodating diverse device capabilities in different frequency bands.

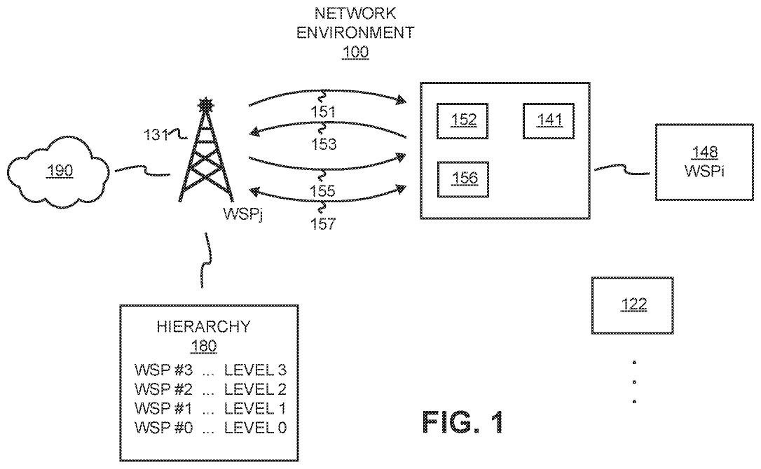

Now, more specifically, with reference to the drawings, FIG. 1 is an example diagram illustrating a network environment and multiple wireless stations negotiating use of a wireless communication security protocol to communicate with each other in a wireless network environment via a wireless security protocol (i.e., a wireless security protocol supporting specific encryption) selected amongst multiple wireless security protocols as discussed herein.

As shown, network environment 100 includes network 190, wireless access point 131 (wireless station, wireless base station, etc.), mobile communication device 121 (wireless station, user equipment, etc.), mobile communication device 122 (wireless station, user equipment, etc.), etc.

Note that the wireless access point 131 (a.k.a., communication management resource 141) can be implemented as communication management hardware, communication management software, or a combination of communication management hardware and communication management software; the mobile communication device 121 (communication management resource) can be implemented as communication management hardware, communication management software, or a combination of communication management hardware and communication management software; the mobile communication device 122 (communication management resource) can be implemented as communication management hardware, communication management software, or a combination of communication management hardware and communication management software; and so on.

The one or more wireless stations (such as wireless access point 131, mobile communication device 121, mobile communication device 122, etc.) in the network environment 100 can be configured to support one or more wireless security protocols (such as Wi-Fi™ protocols or other suitable communication protocols) ranked at different levels in a respective hierarchy 180.

In this example, the hierarchy 180 includes wireless communication security protocol WSP #3 (such as WPA 3) at level 3, wireless communication security protocol WSP #2 (such as WPA #2) at level 2, wireless communication security protocol WSP #1 (such as WPA at level 1), wireless communication security protocol WSP #0 (such as WEP at level 0), etc.

Each wireless security protocol in the hierarchy 180 can be configured to support a different security level for communicating over a respective wireless communication link between the wireless access point 131 and a respective mobile communication device. The wireless security protocol #0 at level 0 such as WEP (Wired Equivalent Privacy) may be implemented via static keys and encryption size of 64 or 128 bits; the wireless security protocol #1 at level 1 such as WPA (Wi-Fi Protected Access) may be implemented via dynamic encryption keys the error and encryption size of 128 bits; the wireless security protocol #2 at level 2 such as WPA2 (Wi-Fi Protected Access 2) may be implemented via dynamic encryption keys having a encryption size of 128-bit or 265-bit; the wireless security protocol #3 at level 3 such as WPA3 may be implemented via dynamic encryption keys (such as unique keys, individualized data encryption) and encryption size of 192 bits or 256 bits.

In one example, it is desirable, if possible, to implement the wireless security protocol ranked highest in the respective hierarchy 180. For example, it is most desirable to implement the wireless security protocol WSP #3 at level 3 in the hierarchy 180 to communicate between the wireless access point 131 and the respective mobile communication device (121) because it provides the highest level of security to protect corresponding transmitted data. The next most desirable wireless security protocol to implement in the hierarchy 180 is wireless security protocol #2 at level 2 in the hierarchy; the next desirable while security protocol to implement in the hierarchy 180 is wireless security protocol #1 at level 1; and so on.

The wireless access point 131 can be configured to support wireless security protocol J, which may indicate any level in the corresponding hierarchy 180. The wireless access point 131 may support just the wireless security protocol as indicated by the value J. In such an instance, if the value J indicates the value of level 1, then the wireless access point only supports the wireless security protocol #1. If the value J indicates the value of level 2, then the wireless access point only supports the wireless security protocol #2, and so on.

Alternatively, the value J assigned to the wireless station may indicate the highest protocol level supported by that wireless station. As previously discussed, the value J may be assigned to the wireless access point 131. The wireless access point 131 may support any wireless security protocol up to and including the value specified by J. For example, if J equals level 1, the wireless access point 131 supports the wireless security protocol #0 and the wireless security protocol #1. If J equals level 2, the wireless access point 131 supports the wireless security protocol #0, wireless a security protocol #1, and wireless security protocol #2. If J equals level 3, the wireless access point supports the wireless security protocol #0, wireless security protocol #1, wireless security protocol #2, and wireless security protocol #3. Accordingly, the value J assigned to the corresponding wireless access point 131 may indicate that the wireless access point 131 supports the wireless security protocol at level J in the hierarchy 180 as well as any level below the level J in the hierarchy 180

In a similar manner, each of the wireless stations such as mobile communication device 121, mobile communication device 122, etc., can be configured to support one or more of the wireless security protocols in the hierarchy 180.

For example, the mobile communication device 121 can be configured to support wireless security protocol I, which may indicate any level in the corresponding hierarchy 180. The mobile communication device 121 may support just the wireless security protocol as indicated by the value I. For example, if the value I indicates the value of level 1, then the wireless access point only supports the wireless security protocol #1. If the value I indicates the value of level 2, then the wireless access point only supports the wireless security protocol #2, and so on.

Alternatively, the mobile communication device 121 may support any wireless security protocol up to the value specified by I assigned to the mobile communication device 121. For example, if I equals level 1, the mobile communication device 121 supports the wireless security protocol #0 and the wireless security protocol #1. If I equals level 2, the wireless access point 131 supports the wireless security protocol #0, while a security protocol #1, and wireless security protocol #2. If I equals level 3, the wireless access point supports the wireless security protocol #0, wireless security protocol #1, while security protocol #2, and wireless security protocol #3. Accordingly, the value I assigned to the corresponding wireless access point 131 may indicate that the wireless access point 131 supports the wireless security protocol at level I in the hierarchy 180 as well as any level below the level I in the hierarchy 180

As further shown in FIG. 1, the wireless station 131 can be configured to transmit communications 151 as a broadcast message from the wireless access point 131 to any of one or more mobile communication devices in the network environment 100. In one example, the communications 151 corresponding one or more wireless security protocols supported by the wireless access point 131 as well as presence and availability of the wireless access point corresponding wireless networks such as wireless network SSID #1, wireless network SSID #2, etc.

Via the operations 152, the recipient mobile communication device 121 processes the received communications 151 (such as specifying the value J) and determines from the communications 151 that the wireless access point 131 supports at least the level J in the hierarchy 180 of wireless security protocols. In other words, the communications 151 indicate that the wireless access point 131 is assigned the level J.

In a reverse direction, via communications 153, the mobile communication device 121 notifies the wireless access point 131 of one or more wireless security protocols supported by the mobile communication device 121. For example, the mobile communication device 121 can be configured to retrieve first protocol information 148 such as including the value I assigned to the mobile communication device 121. The mobile communication device 121 can be configured to generate corresponding communications 153 to indicate a value of I representing a corresponding level (and respective wireless security protocol #I) in the hierarchy 180 assigned to the mobile communication device 121. In one example, the communications 153 such including a notification is a probe request message generated by the mobile communication device 121. Thus, via communications 153 and corresponding data value I, the mobile communication device 121 notifies the wireless access point 131 of at least a corresponding level I of a wireless security protocol in the hierarchy 180 supported by the mobile communication device 121. Accordingly, the wireless base wireless access point 131 is notified by the mobile communication device 121 of the one or more wireless security protocols supported by the mobile communication device 121.

In response to receiving the communications 153, the wireless access point 131 generates and transmits respective response communications 155 from the wireless access point 131 to the mobile communication device 121. In one example, the communications 155 further indicate the one or more wireless security protocols supported by the wireless access point 131. For example, the communications 155 may further include the numerical value J indicating a corresponding level in the hierarchy. As previously discussed, communication of the numerical value J notifies the mobile communication device 121 of a corresponding level J in the hierarchy 180 supported by the wireless access point 131.

Via further operations 156, the mobile communication device 121 selects an appropriate wireless security protocol to support subsequent communications between the mobile communication device 121 and the wireless access point 131. As further discussed herein, the selected wireless security protocol is based on the numerical value J signed to the wireless access point 131 and the numerical value I assigned to the mobile communication device 121.

The selected wireless security protocol (whether it be level I or level J or some other level in the hierarchy 180) is subsequently used as a basis in which to initiate establish a respective wireless communication link between the mobile communication device 121 and the wireless access point 131 after the discovery phase.

More specifically, the above operations and communications may occur during a respective discovery phase of the mobile communication device 121 wirelessly connecting to the wireless access point 131. The wireless security protocol eventually selected by the mobile communication device 121 is then used as a basis in which to establish a respective wireless communication link between the mobile communication device 121 and the wireless access point 131.

For example, assume that the mobile communication device 121 selects level I (which may be the same or different than level J) and corresponding wireless security protocol as a basis in which to establish a wireless communication link with the wireless access point 131. In such an instance, via communications 157 (such as supporting authentication, association, 4-way handshake, etc., of the mobile communication device 121 with the wireless access point 131), the mobile communication device 121 implements the wireless security protocol associated with level I to establish the corresponding wireless communication link with the wireless access point 131.

As another example, assume that the mobile communication device 121 selects level J (which may be the same or different than level I) and corresponding wireless security protocol as a basis in which to establish a wireless communication link with the wireless access point 131. In such an instance, via communications 157 (such as supporting one or more operations including authentication, association, 4-way handshake, etc., of the mobile communication device 121 with the wireless access point 131), the mobile communication device 121 implements the wireless security protocol associated with level J to establish the corresponding wireless communication link with the wireless access point 131.

Accordingly, if supported by the wireless access point 131, the mobile communication device 121 may select the highest level of wireless security protocol hierarchy 180 supported by both the mobile communication device 121 and the wireless station 131.

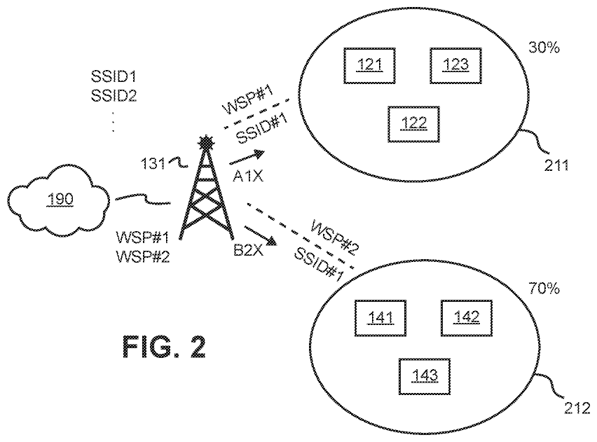

FIG. 2 is an example diagram illustrating communication of wireless beacons from a wireless access point for each of multiple different wireless security protocols associated with a first wireless network as discussed herein.

In this example, assume that the wireless access point 131 supports multiple wireless networks including wireless network named SSID #1, wireless network named SSID #2, etc.

Each of the different wireless network supported by the wireless access point may support the same or different one or more wireless security protocols.

Assume in this example that the wireless access point 131 supports wireless connectivity with each of the different communication devices in a first group of communication devices 211 using the wireless security protocol #1 and corresponding wireless network SSID #1. Assume further this example that the wireless access point 131 supports wireless connectivity with each of the different communication devices in a second group of communication devices 212 using the wireless security protocol #2 corresponding wireless network SSID #2.

Accordingly, both the communication devices in group 211 and group 212 are connected to the same wireless network SSID #1 supported by the wireless access point 131. However, the communication devices in the group 211 communicate with the wireless access point 131 in accordance with the wireless security protocol #1; the communication devices in the group 212 communicate with the wireless access point 131 in accordance with the wireless security protocol #2.

Assume further in this example that the wireless access point 131 or other suitable entity keeps track of the number of communication devices in the group 211 and the number of communication devices in the group 212. More specifically, the number of communication devices in group 211 may be 30 and the number of communication devices in group 212 may be 70. This means that 30 percent of the total of 100 communication devices use the wireless network SSID #1 and wireless security protocol #1 supported by the wireless station 131; further, this means that 70 percent of the total of 100 communication devices use the wireless network SSID #1 and wireless security protocol #2 supported by the wireless access point 131.

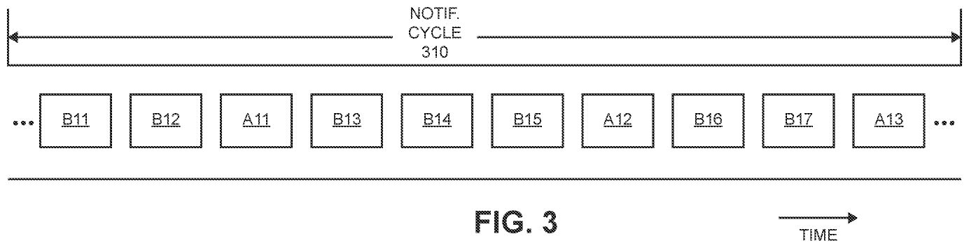

As further shown in FIG. 3, the wireless access point 131 can be configured to generate and transmit the presence and availability information (such as beacons) depending on a corresponding ratio of users using the wireless security protocol #1 versus the wireless security local #2 for the corresponding wireless network SSID #1.

FIG. 3 is an example diagram illustrating a ratio of broadcasting different beacons for different wireless security protocols associated with the first wireless network as discussed herein.

As previously discussed, the wireless access point 131 can be configured to provide notification of its availability (including an identity of the available wireless network SSID # as well as one or more wireless security protocols supported by that wireless network).

In this example, 30 percent (30 communication devices divided by 100 total communication devices) of the communication devices using the wireless network SSID #1 communicate with the wireless access point 131 via use of the wireless security protocol #1; 70 percent (70 communication devices divided by 100 total communication devices) of the communication devices using the wireless network SSID #1 communicate with the wireless access point 131 via use of the wireless security protocol #2.

The wireless access point 131 uses the ratio information 30/70 (or 30/100 or 70/100) as a basis in which to control how many beacon messages are communicated in in a corresponding notification cycle 310 (such as 100 milliseconds or other suitable amount including 10 transmitted beacon notifications) for each of the different available wireless security protocols. The notification cycle 310 can be any suitable time duration. Assume that the wireless access point 131 is configured to transmit a total of 10 availability notifications (such as beacons) to any wireless stations in the network environment 100 for the given notification cycle 310. Because 30 percent of the supported communication devices (group 211) communicate with the wireless access point 131 via the wireless security protocol #1 for SSID #1, the wireless access point 131 generates 30 percent of the total notifications (i.e., A11, A12, A13) in the notification cycle 310 to indicate that the wireless access point 131 supports the wireless security protocol #1.

Because 70 percent of the supported communication devices (group 212) communicate with the wireless access point 131 via the wireless security protocol #2 for SSID #1, the wireless access point 131 generates 70 percent of the total notifications (B11, B12, B13, B14, B15, B16, B17) in the notification cycle 310 to indicate that the wireless access point 131 supports the wireless security protocol #2.

Thus, the wireless access point 131 (such as a second wireless station) can be configured to transmit first beacons (wireless messages A11, A12, A13) indicating that the wireless access point 131 supports the first wireless security protocol (wireless security protocol #1). The wireless access point 131 can be configured to transmit second beacons (wireless messages B11, B12, B13, B14, B15, B16, B17) indicating that the wireless access point 131 supports a second wireless security protocol (wireless security protocol #2). In one example, the second wireless security protocol #2 is different than the first wireless security protocol #1.

As previously as discussed, a ratio of the first beacons (A11, A12, A13) with respect to the second beacons (B11, B12, B13, B14, B15, B16, B17) transmitted by the wireless access point 131 is based upon a number of first communication devices (such as communication devices 121, 122, 123, etc.) in group 211 wirelessly connected to the wireless access point 310 via the first wireless security protocol #1 versus a number of second communication devices (such as communication devices 141, 142, 143, etc.) in group 212 wirelessly connected to the wireless access point 131 via the second wireless security protocol #2.

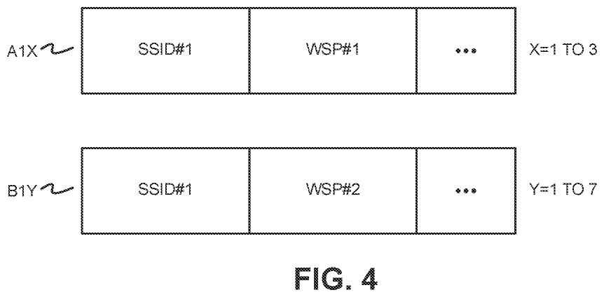

Additional details of the corresponding notifications (such as beacons) are shown in FIG. 4.

FIG. 4 is an example diagram illustrating multiple beacons advertising support for different wireless security protocols associated with the first wireless network as discussed herein.

Note that each of the notifications indicating presence of the wireless access point 131 in the network environment 100 can be configured to include any suitable information such as the corresponding name (SSID known as Service Set IDentifier) of the wireless network supported by the wireless access point 131, identities of one or more wireless security protocols supported by the wireless access point 131 for the corresponding wireless network, highest level of the wireless security protocol in the hierarchy 180 that is supported by the wireless access point 131 for the given wireless network SSID #, etc.

Accordingly, in this example, each of the notifications A1x (where x equals 1 to 3) includes information such as the name of the wireless network SSID #1 available for use as well as one or more corresponding wireless security protocols (at least wireless security protocol #1) supported by the wireless access point for that wireless network SSID #1.

In this example, each of the notifications Bly (where y equals 1 to 7) includes information such as the name of the wireless network SSID #1 available for use as well as one or more corresponding wireless security protocols (at least wireless security protocol #2) supported by the wireless access point for that wireless network SSID #1.

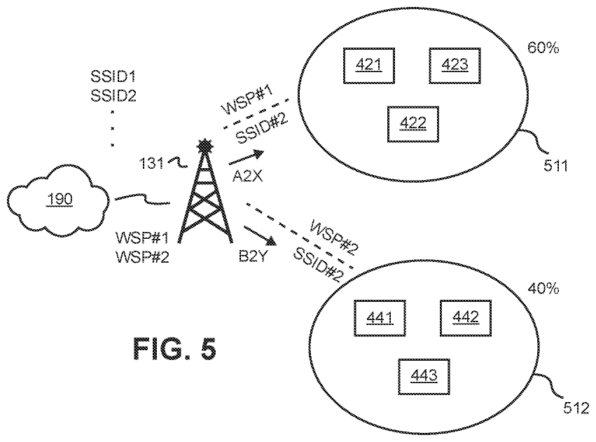

FIG. 5 is an example diagram illustrating communication of wireless beacons for each of multiple different wireless security protocols associated with a second wireless network as discussed herein.

In this example, the wireless access point 131 supports multiple wireless networks including wireless network named SSID #1, wireless network named SSID #2, etc. Each of the different wireless network supported by the wireless access point may support the same or different one or more wireless security protocols.

Assume in this example that the wireless access point 131 supports wireless connectivity with each of the different communication devices in a third group 511 of communication devices using the wireless security protocol #1 and corresponding wireless network SSID #2. Assume further this example that the wireless access point 131 supports wireless connectivity with each of the different communication devices in a fourth group 512 of communication devices using the wireless security protocol #2 and corresponding wireless network SSID #2.

Accordingly, both the communication devices in group 511 and group 512 are connected to the same wireless network SSID #2 associated with the wireless access point 131. However, the communication devices (such as communication devices 421, 422, 423, etc.) in the group 511 communicate with the wireless access point 131 in accordance with the wireless security protocol #1; the communication devices (such as communication devices 441, 442, 443, etc.) in the group 512 communicate with the wireless access point 131 in accordance with the wireless security protocol #2.

Assume further in this example that the wireless access point 131 keeps track of the number of communication devices in the group 511 and the number of communication devices in the group 512. More specifically, the number of communication devices in group 511 may be 60 and the number of communication devices in group 512 may be 40. This means that 60 percent of total communication devices use the wireless network SSID #2 and wireless security protocol #1 supported by the wireless station 131; further, this means that 40 percent of the communication devices use the wireless network SSID #2 and wireless security protocol #2 supported by the wireless access point 131.

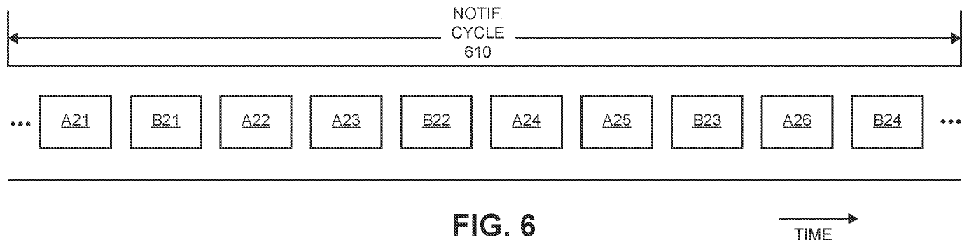

As further shown in FIG. 6, the wireless access point 131 can be configured to generate and transmit the availability information of the wireless services provided by the wireless a station 131 depending on a corresponding ratio of users (communication devices) using the wireless security protocol #1 versus the wireless security protocol #2 for the corresponding wireless network SSID #2.

FIG. 6 is an example diagram illustrating a ratio of broadcasting different beacons for different wireless security protocols associated with the second wireless network as discussed herein.

As previously discussed, the wireless access point 131 can be configured to provide notification of its availability (including an identity of the available wireless network SSID # as well as one or more wireless security protocols supported by that wireless network).

In this example, 60 percent (60 communication devices divided by 100 total communication devices) of the communication devices using the wireless network SSID #2 communicate with the wireless access point 131 via use of the wireless security protocol #1; 40 percent (40 communication devices divided by 100 total communication devices) of the communication devices using the wireless network SSID #2 to communicate with the wireless access point 131 via use of the wireless security protocol #2.

The wireless access point 131 uses the ratio information as a basis in which to control how many beacon messages are communicated in in a corresponding notification cycle (such as 100 milliseconds or other suitable amount including 10 transmitted beacon notifications) for each of the different available wireless security protocols. The notification cycle 610 can be any suitable time duration.

Assume that the wireless access point 131 is configured to transmit a total of 10 availability notifications (such as beacons) to any wireless stations in the network environment 100 for the given notification cycle 610. Because 60 percent of the supported communication devices (group 511) communicate with the wireless access point 131 via the wireless security protocol #1 for SSID #2, the wireless access point 131 generates 60 percent of the total notifications (A21, A22, A23, A24, A25, A26) in the notification cycle 610 to indicate that the wireless access point 131 supports the wireless security protocol #1.

Because 40 percent of the supported communication devices (group 512) communicate with the wireless access point 131 via the wireless security protocol #2 for SSID #2, the wireless access point 131 generates 40 percent of the total notifications (B21, B22, B23, B24) in the notification cycle 610 to indicate that the wireless access point 131 supports the wireless security protocol #2.

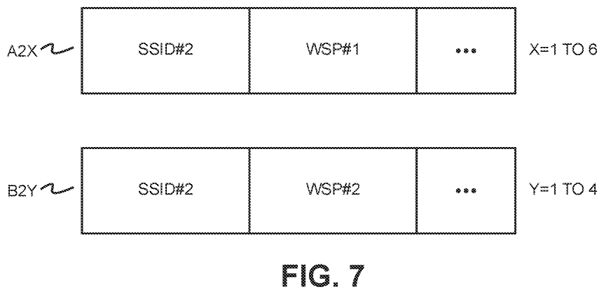

Additional details of the corresponding notifications (such as beacons) are shown in FIG. 7.

FIG. 7 is an example diagram illustrating multiple beacons advertising support for different wireless security protocols associated with the first wireless network as discussed herein.

Note that each of the notifications indicating presence of the wireless access point 131 in the network environment 100 can be configured to include any suitable information such as the corresponding name of the wireless network supported by the wireless access point 131, identities of one or more wireless security protocols supported by the wireless access point 131 for the corresponding wireless network, highest level of the wireless security protocol in the hierarchy 180 that is supported by the wireless access point 131 for the given wireless network SSID #, etc.

Accordingly, in this example, each of the notifications A2x (where x equals 1 to 6) includes information such as the name of the wireless network SSID #2 available for use as well as one or more corresponding wireless security protocols (at least wireless security protocol #1) supported by the wireless access point for that wireless network SSID #2.

In this example, each of the notifications B2y (where y equals 1 to 4) includes information such as the name of the wireless network SSID #2 available for use as well as one or more corresponding wireless security protocols (at least wireless security protocol #2) supported by the wireless access point for that wireless network SSID #2.

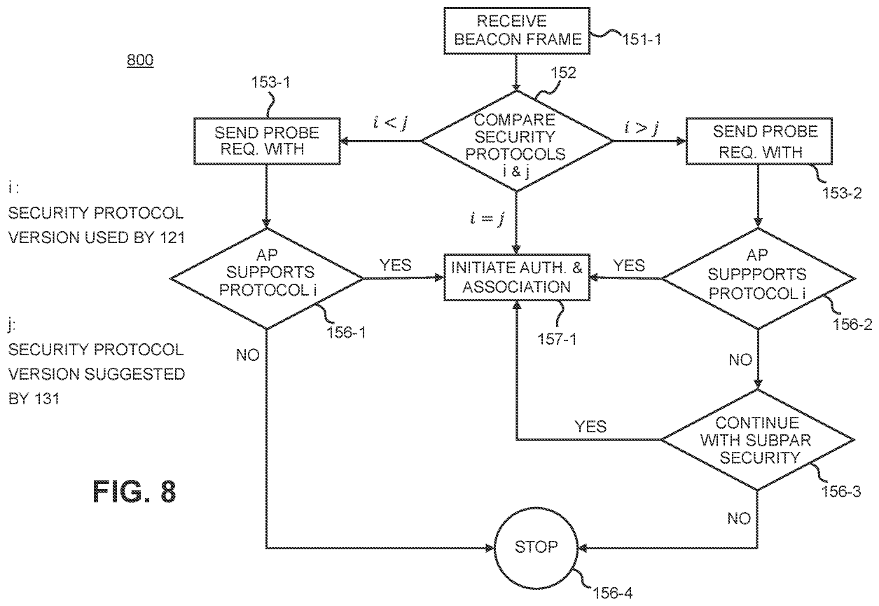

FIG. 8 is an example diagram illustrating implementation of operations by a mobile communication device to select a wireless security protocol as discussed herein.

In this example, the mobile communication device 121 implements the operations in the flowchart 800 of FIG. 8 via a passive scanning by the mobile communication device 121 for the availability of one or more different wireless access points in the network environment 100.

In one example, the mobile communication device 121 retrieves first protocol information 148 assigned to the mobile communication device 121. The first protocol information 148 indicates that the mobile communication device 121 is assigned the value I, which indicates the corresponding level of wireless security protocol in the hierarchy 180 supported by the mobile communication device 121.

In processing operation 151-1, the mobile communication device 121 receives communications 151 from the wireless access point 131. As previously discussed, the received communications 151 communicate a corresponding one or more wireless security protocol supported by the wireless access point 131. The received communications 151 may include the value J suggested by the access point 131 to support wireless connectivity between the wireless access point 131 and the mobile communication device 121. As previously discussed, the value J indicates a corresponding level in the hierarchy 180 supported by the wireless access point 131.

Thus, prior to transmitting a respective probe request (notification), the mobile communication device 121 can be configured to receive one or more beacon frames from the wireless access point 131. As previously discussed, the beacon frame (one or more beacon notifications such as A11, A12, A13, . . . , B11, B12, . . . ) indicates one or more wireless security protocols supported by the wireless access point 131 for a respective one or more network names SSID.

In subsequent operations, the mobile communication device 121 selects a wireless security protocol in which to communicate with the second wireless station (wireless access point 131) based on the first protocol information (assigned a first level I in the hierarchy 180 such as level 0, level 1, level 2, or level 3) and second protocol information (assigned a second level J in the hierarchy 180 such as level 0, level 1, level 2, or level 3) received from the wireless access point 131. As further discussed below, in response to selection of a corresponding wireless security protocol (such as wireless security protocol I, wireless security protocol J, or another wireless security protocol in the hierarchy 180), the mobile communication device 121 establishes a respective wireless communication link between the mobile communication device and the wireless access point using the selected wireless security protocol.

More specifically, as further shown in flowchart 800, in operation 152, the mobile communication device (i.e., communication management resource) compares the security protocol value I assigned to the mobile communication device 121 and the wireless security protocol J supported by the wireless access point 131 as indicated by the communications 151. If the value I is equal to J, mobile communication device 121 initiates execution of the processing operations 157-1. As previously discussed, this can include conveyance of communications 157 (such as communications including one or more of association, authentication, four-way handshake, etc.) between the mobile communication device 121 and the wireless access point 131.

In operation 152, if the mobile communication device 121 determines that the value I assigned to the mobile communication device 121 is less than the value J received from the wireless access point 131, the mobile communication device 121 transmits communications 153 to the wireless access point 131 in operation 153-1. In one example, the mobile communication device 121 transmits a notification (such as in communications 153) to the wireless access point 131, where the notification indicates the first wireless security protocol I supported by the mobile communication device 121. The notification in communications 153 may include a probe request transmitted by the mobile communication device 121 to learn of an identity of one or more wireless networks (such as SSID #1, SSID #2, SSID #3, etc.) supported by the wireless access point 131. Thereafter, in operation 156-1, the mobile communication device 121 determines whether the wireless access point 131 supports the wireless security protocol I. If so, the mobile communication device 121 selects the wireless security protocol I and initiates execution of operation 157-1 to establish corresponding wireless communication link with the wireless access point 131 using the wireless security protocol I. On the other hand, if the mobile communication device 121 determines that the wireless access point 131 does not support the wireless security protocol I, the mobile communication device 121 terminates the attempt to establish wireless connectivity with the wireless access point 131 via execution of the operation 156-4.

In operation 152, if the mobile communication device 121 determines that the value I assigned to the mobile communication device 121 is greater than the value J received from the wireless access point 131, the mobile communication device 121 transmits communications 153 to the wireless access point 131 in operation 153-2. In one example, the mobile communication device 121 transmits a notification (such as in communications 153) to the wireless access point 131, where the notification indicates the first wireless security protocol I supported by the mobile communication device 121. The notification in communications 153 may include or be a probe request transmitted by the mobile communication device 121 to learn of an identity of one or more wireless networks (such as SSID #1, SSID #2, SSID #3, etc.) supported by the wireless access point 131. Thereafter, in operation 156-2, the mobile communication device 121 determines whether the wireless access point 131 supports the wireless security protocol I. If so, the mobile communication device 121 selects the wireless security protocol I and initiates execution of operation 157-1 to establish corresponding wireless communication link with the wireless access point 131 using the wireless security protocol I. On the other hand, if the wireless access point 131 does not support the wireless security protocol I, the mobile communication device 121 continues with executing operation 156-3.

In operation 156-3, mobile communication device 121 decides whether it should continue establish a wireless communication link with the wireless access point 131 using a wireless security protocol J or some other wireless security protocol less than level I. If so, the mobile communication device 121 selects wireless security protocol J or some other wireless security protocol less than level I became with the wireless access point 131 in operation 157-1. Alternatively, in processing operation 156-3, if the mobile communication device does not select wireless security protocol J or some other wireless security protocol less than level I, the mobile communication device 121 terminates the attempt to establish wireless connectivity with the wireless access point 131 via execution of the operation 156-4.

As previously discussed, note that the second protocol information (such as value J received by the mobile communication device 121 from the wireless access point 131) can be configured to indicate identities of multiple wireless security protocols supported by the wireless access point 131. The identities of the multiple wireless security protocols as indicated by the second protocol information such as received in communications 155 may indicate both the wireless security protocol I and the wireless security protocol J. The first wireless security protocol I may correspond to a first level in a tiered hierarchy of multiple wireless security protocols; the second wireless security protocol J may correspond to a second level in the tiered hierarchy 180 of multiple wireless security protocols, the second level ranking higher than the first level.

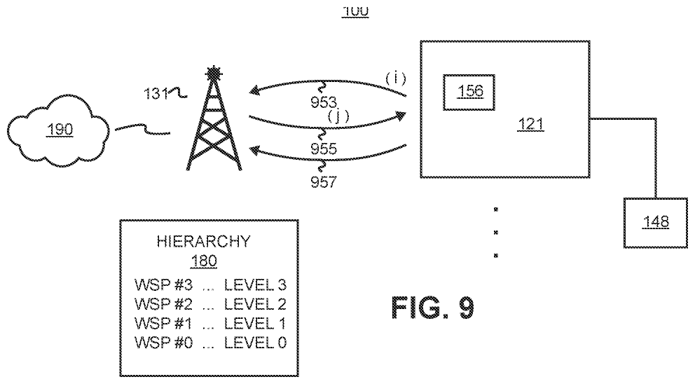

FIG. 9 is an example diagram illustrating a network environment and multiple wireless stations negotiating use of a wireless security protocol to communicate with each other in a wireless network environment as discussed herein.

As shown, network environment 100 includes network 190, wireless access point 131 (wireless station), mobile communication device 121 (wireless station), mobile communication device 122 (wireless station), etc.

Each of the mobile communication devices in network environment 100 establishes a respective wireless communication link with the wireless access point to communicate through the wireless access point 131 to the one or more target entities in the network 190. Accordingly, the wireless access point 131 provides each of the mobile communication devices access to the network 190.

The one or more wireless stations (such as wireless access point 131, mobile communication device 121, mobile communication device 122, etc.) in the network environment 100 can be configured to support one or more wireless security protocols ranked in a respective hierarchy 180.

In this example, the hierarchy 180 includes wireless communication security protocol WSP #3 (such as WPA 3) at level 3, wireless communication security protocol WSP #2 (such as WPA #2) at level 2, wireless communication security protocol WSP #1 (such as WPA at level 1), wireless communication security protocol WSP #0 (such as WEP at level 0), etc.

Each wireless security protocol in the hierarchy 180 can be configured to support a different security level for communicating over a respective wireless communication link between the wireless access point and a respective mobile communication device. The wireless security protocol #0 at level 0 such as WEP may be implemented via static keys and encryption size of 64 or 128 bits; the wireless security protocol #1 at level 1 such as WPA may be implemented via dynamic encryption keys the error and encryption size of 128 bits; the wireless security protocol #2 at level 2 such as WPA2 may be implemented via dynamic encryption keys having a encryption size of 128-bit or 265-bit; the wireless security protocol #3 at level 3 such as WPA3 may be implemented via dynamic encryption keys (such as unique keys, individualized data encryption) and encryption size of 192 bits or 256 bits.

In one example, it is desirable, if possible, to implement the wireless security protocol ranked highest in the respective hierarchy 180. For example, it is most desirable to implement the wireless security protocol WSP #3 at level 3 in the hierarchy 180 to communicate between the wireless access point 131 and the respective mobile communication device (121) because it provides the highest level of security to protect corresponding transmitted data. The next most desirable wireless security protocol to implement is wireless security protocol #2 at level 2 and hierarchy; the next desirable while security protocol to implement 180; and so on.

The wireless access point 131 can be configured to support wireless security protocol J, which may indicate any level in the corresponding hierarchy 180. The wireless access point 131 may support just the wireless security protocol as indicated by the value J. In such an instance, if the value J indicates the value of level 1, then the wireless access point only supports the wireless security protocol #1. If the value J indicates the value of level 2, then the wireless access point only supports the wireless security protocol #2, and so on.

Alternatively, the value assigned to the wireless station may indicate the highest protocol level supported by that wireless station. As previously discussed, the value J side to the wireless access point 131. The wireless access point 131 may support any wireless security protocol up to and including the value specified by J. For example, if J equals level 1, the wireless access point 131 supports the wireless security protocol #0 and the wireless security protocol #1. If J equals level 2, the wireless access point 131 supports the wireless security protocol #0, wireless a security protocol #1, and wireless security protocol #2. If J equals level 3, the wireless access point supports the wireless security protocol #0, wireless security protocol #1, wireless security protocol #2, and wireless security protocol #3.

In a similar manner, each of the wireless stations such as mobile communication device 121, mobile communication device 122, etc., can be configured to support one or more of the wireless security protocols in the hierarchy 180.

For example, the mobile communication device 121 can be configured to support wireless security protocol I as indicated by the protocol information 148, which may indicate any level in the corresponding hierarchy 180. The mobile communication device 121 may support just the wireless security protocol as indicated by the value I. For example, if the value I indicates the value of level 1, then the wireless access point only supports the wireless security protocol #1. If the value I indicates the value of level 2, then the wireless access point only supports the wireless security protocol #2, and so on.

Alternatively, the mobile communication device 121 may support any wireless security protocol up to the value specified by J assigned to the mobile communication device 121. For example, if J equals level 1, the mobile communication device 121 supports the wireless security protocol #0 and the wireless security protocol #1. If J equals level 2, the wireless access point 131 supports the wireless security protocol #0, while a security protocol #1, and wireless security protocol #2. If J equals level 3, the wireless access point supports the wireless security protocol #0, wireless security protocol #1, while security protocol #2, and wireless security protocol #3.

Via communications 953, the mobile communication device 121 notifies the wireless access point 131 of one or more wireless security protocols supported by the mobile communication device 121. For example, the mobile communication device 121 can be configured to retrieve first protocol information 148 such as including the value I assigned to the mobile communication device 121. The mobile communication device 121 can be configured to generate corresponding communications 953 to indicate a value of I representing a corresponding level (and respective wireless security protocol #I) in the hierarchy 180 assigned to the mobile communication device 121. In one example, the communications 953 such including a notification is a probe request generated by the mobile communication device 121. Thus, via communications 953 and corresponding data value I in the communications 953, the mobile communication device 121 notifies the wireless access point 131 of at least a corresponding level I of a wireless security protocol in the hierarchy 180 supported by the mobile communication device 121.

In response to receiving the communications 953, the wireless access point 131 generates and transmits respective response communications 955 from the wireless access point 131 to the mobile communication device 121. In one example, the communications 955 further indicate the one or more wireless security protocols supported by the wireless access point 131. For example, the communications 955 may further include the numerical value J indicating a corresponding level in the hierarchy. As previously discussed, communication of the numerical value J notifies the mobile communication device 121 of at least one corresponding level J in the hierarchy 180 supported by the wireless access point 131.

Via further operations 956, the mobile communication device 121 selects an appropriate wireless security protocol to support subsequent communications between the mobile communication device 121 and the wireless access point 131. The selected wireless security protocol is based on the numerical value J signed to the wireless access point 131 and the numerical value I assigned to the mobile communication device 121.

The selected wireless security protocol (whether it be level I or level J or some other level in the hierarchy 180) is subsequently used as a basis in which to initiate establishing a respective wireless communication link between the mobile communication device 121 and the wireless access point 131.

More specifically, the above operations and communications may occur during a respective discovery phase of the mobile communication device 121 wirelessly connecting to the wireless access point 131. The wireless security protocol eventually selected by the mobile communication device 121 is then used as a basis in which to establish a respective wireless communication link between the mobile communication device 121 and the wireless access point 131.

For example, assume that the mobile communication device 121 selects level I (which may be the same or different than level J) and corresponding wireless security protocol as a basis in which to establish a wireless communication link with the wireless access point 131. In such an instance, via communications 957 (such as supporting authentication, association, 4-way handshake, etc., of the mobile communication device 121 with the wireless access point 131), the mobile communication device 121 implements the wireless security protocol associated with level I to establish the corresponding wireless communication link with the wireless access point 131.

As another example, assume that the mobile communication device 121 selects level J (which may be the same or different than level I) and corresponding wireless security protocol as a basis in which to establish a subsequent wireless communication link with the wireless access point 131. In such an instance, via communications 957 (such as supporting authentication, association, 4-way handshake, etc., of the mobile communication device 121 with the wireless access point 131), the mobile communication device 121 implements the wireless security protocol associated with level J to establish the corresponding wireless communication link with the wireless access point 131.

Accordingly, if supported by the wireless access point 131, the mobile communication device 121 may select the highest level of wireless security protocol hierarchy 180 supported by both the mobile communication device 121 and the wireless station 131.

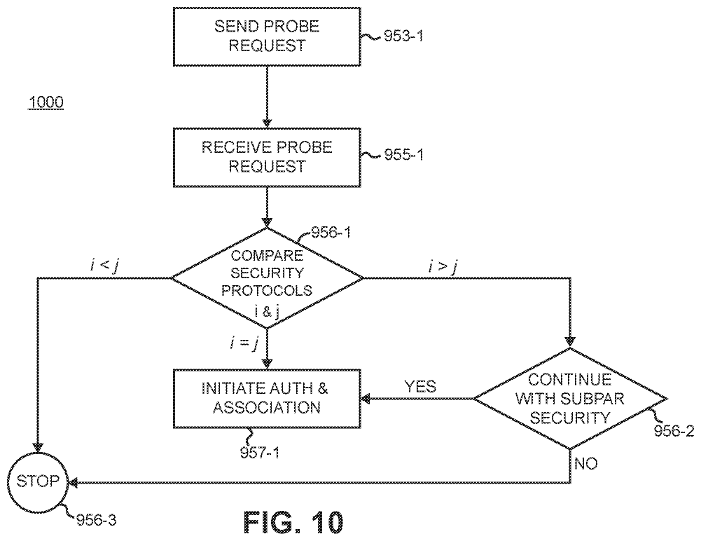

FIG. 10 is an example diagram illustrating implementation of operations by a mobile communication device to select a wireless security protocol as discussed herein. In this example, the mobile communication device 121 implements the operations in the flowchart 1000 of FIG. 10 via active scanning by the mobile communication device 121 for the availability of one or more different wireless access points in the network environment 100.

In one example, at any suitable time, the mobile communication device 121 retrieves first protocol information 148 assigned to the mobile communication device 121. The first protocol information 140 indicates that the mobile communication device 121 is assigned the value I, which indicates the corresponding level of wireless security protocol in the hierarchy 180 supported by the mobile communication device 121.

In subsequent operations, the mobile communication device 121 selects a wireless security protocol in which to communicate with the second wireless station based on the first protocol information (assigned a first level I in the hierarchy 180 such as level 0, level 1, level 2, or level 3) and second protocol information (assigned a second level J in the hierarchy 180 such as level 0, level 1, level 2, or level 3) received from the wireless access point 131.

As further discussed below, in response to selection of a corresponding wireless security protocol (such as wireless security protocol I, wireless security protocol J, or another wireless security protocol in the hierarchy 180), the mobile communication device 121 establishes a respective wireless communication link between the mobile communication device and the wireless access point using the selected wireless security protocol.

More specifically, as further shown in flowchart 1000, in operation 953-1, the mobile communication device 121 transmits communications 953 such as a probe request to the wireless access point 131. As previously discussed, the communications 953 can include a respective numerical value I assigned to the mobile communication device 121. Further, as previously discussed, the numerical value I in the communications 953 indicating that the mobile communication device 121 is assigned the level I in the hierarchy 180.

As a response to transmitting the communications 953 to the wireless access point 131, the wireless access point transmits the communications 955 to the mobile communication device 121. The communications 955 include the numerical value J assigned to the wireless access point 131. Accordingly, the mobile communication device 121 is informed of the corresponding level J in the hierarchy 180 assigned to the wireless access at 131.

In operation 956-1, if the mobile communication device 121 determines that the value I assigned to the mobile communication device 121 is less than the value J received from the wireless access point 131, the mobile communication device 121 executes operation 956-3, which includes terminating the attempt to establish a wireless communication link with the wireless access point 131. In other words, the mobile communication device 121 can be configured to terminate an attempt to establish a wireless communication link with the wireless access point 131 in response to detecting a condition in which the wireless access point 131 does not support a sufficiently high level in the hierarchy 180. The mobile communication device 121 would like to use the wireless security protocol associated with level I (such as level 3), but the wireless access point 131 only supports level J (such as level 2).

Yet further, the communications 955 received from the wireless access point 131 may indicate that the wireless access point 131 supports level J. In operation 956-1, the mobile communication device 121 may detect that level I is equal to level J. In such an instance, the mobile communication device 131 executes the operation 957-1 because the wireless access point 131 supports the same level of wireless security protocol as the mobile communication device 121. Operation 957-1 includes the mobile communication device 121 establishing a wireless communication link with the wireless access point 131 using the wireless security protocol at level I, which is the same as level J.

In operation 956-1, if the mobile communication device 121 determines that the value I assigned to the mobile communication device 121 is greater than the value J received from the wireless access point 131, the mobile communication device 121 executes operation 956-2, which includes execution of the operation 956-2. In operation 956-2, the mobile communication device 121 determines whether or not to establish a respective wireless communication link with the wireless access point 131 using a wireless security protocol at a level below level I assigned to the mobile communication device 121. If the mobile communication device 131 is okay with use of the wireless security protocol associated with level J, the mobile communication device executes the operation 907-1 using the level J. Alternatively, in operation 956-2, the mobile communication device 121 can decide to execute operation 956-3 during a condition in which the mobile communication device 121 does not want to establish a corresponding wireless communication link with the wireless access point 131 using a wireless security protocol at a level below level I such as at level J when J<I.

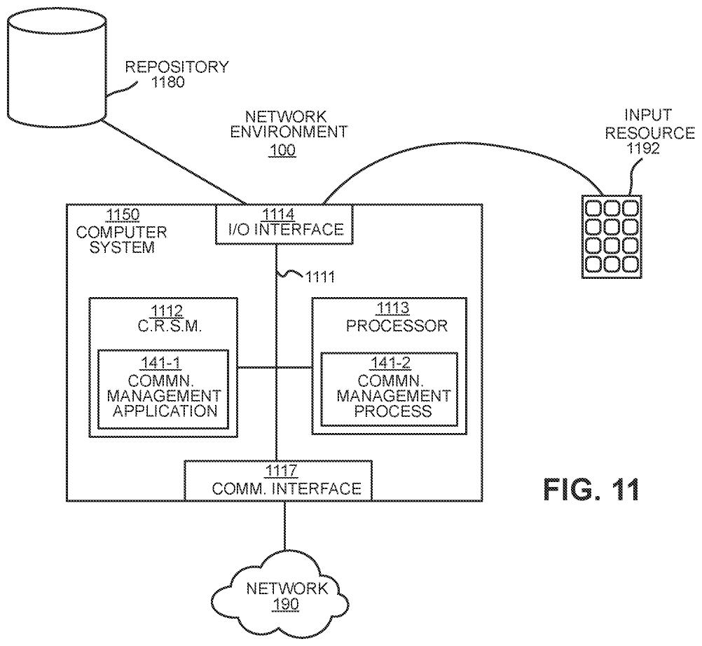

FIG. 11 is an example block diagram of a computer system for implementing any of the operations as previously discussed according to examples herein.

Any of the resources (such as wireless stations, communication management resource associated with wireless access point 131, communication management resource associated with mobile communication device 121, wireless access point 131, mobile communication device 121, etc.) as discussed herein can be configured to include computer processor hardware and/or corresponding executable instructions to carry out the different operations as discussed herein via computer system 1150.

As shown, computer system 1150 of the present example includes an interconnect 1111 coupling computer readable storage media 1112 such as a non-transitory type of media (or more generally, computer readable hardware which can be any suitable type of hardware storage medium in which digital information can be stored and retrieved), a processor 1113 (computer processor hardware), I/O interface 1114, and a communications interface 1117.

I/O interface(s) 1114 supports connectivity to repository 1180 and input resource 1192.

Computer readable storage medium 1112 (such as computer readable hardware or other suitable entity) can be any hardware storage device such as memory, optical storage, hard drive, floppy disk, etc. In one example, the computer readable storage medium 1112 stores instructions and/or data.

As shown, computer readable storage media 1112 can be encoded with management application 140-1 (e.g., including instructions) to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein. In one example, the control system 1150 can include or be implemented in virtualization environments such as the cloud.

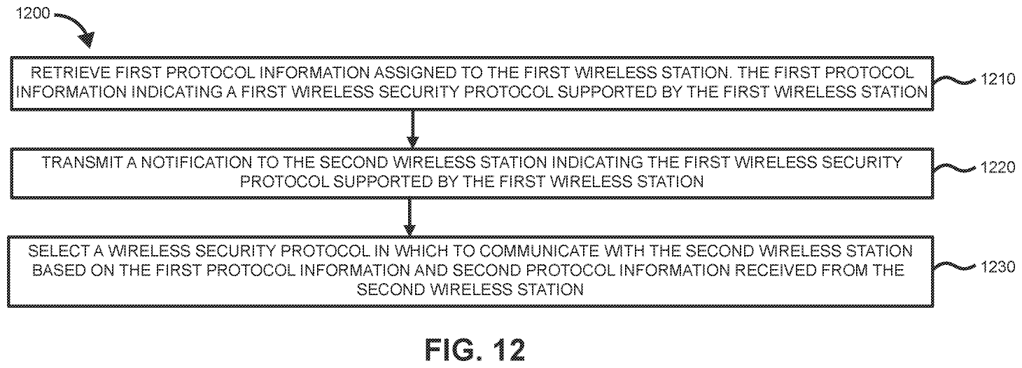

Functionality supported by the different resources will now be discussed via flowchart in FIG. 12. Note that the steps in the flowcharts below can be executed in any suitable order.

FIG. 12 is a flowchart 1200 illustrating an example method according to examples. Note that flowchart 1200 overlaps/captures general concepts as discussed herein.

In processing operation 1210, the communication management resource 141 of the wireless station (121) retrieves first protocol information 148 (such as value J) assigned to the first wireless station (121). The first protocol information indicates a first wireless security protocol supported by the first wireless station such as the mobile communication device 121.

In processing operation 1220, the communication management resource 141 transmits a notification to a second wireless station (such as the wireless access point 131) indicating the first wireless security protocol (such as value I) supported by the first wireless station.

In processing operation 1230, the communication management resource 141 selects a wireless security protocol in which to communicate with the second wireless station based on the first protocol information and second protocol information received from the second wireless station.

Note again that techniques herein are well suited to facilitate selection of a corresponding wireless security protocol to support wireless communications between a first wireless station and a second wireless station. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
at a first wireless station:
retrieving first protocol information assigned to the first wireless station, the first protocol information indicating a first wireless security protocol supported by the first wireless station;
transmitting a notification to a second wireless station indicating the first wireless security protocol supported by the first wireless station; and
selecting a wireless security protocol in which to communicate with the second wireless station based on the first protocol information and second protocol information, the second protocol information received from the second wireless station.

2. The method as in claim 1, wherein the second protocol information indicates the first wireless security protocol; and
wherein the notification is a probe request transmitted by the first wireless station to learn of an identity of a wireless network supported by the second wireless station.

3. The method as in claim 2, wherein the selected wireless security protocol is the first wireless security protocol, the method further comprising:
in response to selection of the first wireless security protocol, establishing a respective wireless communication link between the first wireless station and the second wireless station using the selected first wireless security protocol.

4. The method as in claim 1 further comprising:
receiving the second protocol information from the second wireless station in response to transmitting the notification; and
wherein the second protocol information indicates a second wireless security protocol different than the first wireless security protocol.

5. The method as in claim 4, wherein the selected wireless security protocol is the second wireless security protocol, the method further comprising:
in response to selection of the second wireless security protocol, establishing a respective wireless communication link between the first wireless station and the second wireless station using the second wireless security protocol.

6. The method as in claim 1, wherein the second protocol information indicates identities of multiple wireless security protocols supported by the second wireless station, the identities of the multiple wireless security protocols indicating the first wireless security protocol and a second wireless security protocol.

7. The method as in claim 6, wherein the first wireless security protocol corresponds to a first level in a tiered hierarchy of multiple wireless security protocols; and
wherein the second wireless security protocol corresponds to a second level in the tiered hierarchy of multiple wireless security protocols, the second level ranking higher than the first level.

8. The method as in claim 1, wherein the selected wireless security protocol is the first wireless security protocol.

9. The method as in claim 1, wherein the selected wireless security protocol is a second wireless security protocol specified by the second protocol information.

10. The method as in claim 1 further comprising:
prior to transmitting the notification, receiving a beacon frame from the second wireless station, the beacon frame indicating at least one wireless security protocol supported by the second wireless station.

11. The method as in claim 1 further comprising:
prior to transmitting the notification, receiving a message from the second wireless station, the message indicating a second wireless communication protocol supported by the second wireless station; and
transmitting the notification from the first wireless station to the second wireless station in response to detecting that the second wireless security protocol supported by the second wireless station is different than the first wireless security protocol supported by the first wireless station.

12. The method as in claim 1 further comprising:
in response to transmitting the notification, receiving a message from the second wireless station indicating that the second wireless station supports the first wireless security protocol; and
wherein selecting the wireless security protocol includes: in response to detecting that the second wireless station supports the first wireless security protocol as indicated by the received message, establishing a wireless communication link between the first wireless station and the second wireless station using the first wireless security protocol.

13. The method as in claim 1 further comprising:
at the first wireless station, receiving a communication from the second wireless station prior to transmitting the notification, the communication indicating an identity of the second wireless station and a second wireless security protocol supported by the second wireless station.

14. The method as in claim 1, wherein the second wireless station is operative to transmit first beacons indicating that the second wireless station supports the first wireless security protocol;
wherein the second wireless station is operative to transmit second beacons indicating that the second wireless station supports a second wireless security protocol, the second wireless security protocol different than the first wireless security protocol; and
wherein a ratio of the first beacons with respect to the second beacons transmitted by the second wireless station is based upon a number of first communication devices wirelessly connected to the second wireless station via the first wireless security protocol versus a number of second communication devices wirelessly connected to the second wireless station via the second wireless security protocol.

15. A system comprising:
communication management hardware operative to:
retrieve first protocol information assigned to the first wireless station, the first protocol information indicating a first wireless security protocol supported by the first wireless station;
transmit a notification to a second wireless station indicating the first wireless security protocol supported by the first wireless station; and
select a wireless security protocol in which to communicate with the second wireless station based on the first protocol information and second protocol information, the second protocol information received from the second wireless station.

16. The system as in claim 15, wherein the second protocol information indicates the first wireless security protocol; and
wherein the notification is a probe request transmitted by the first wireless station to learn of an identity of a wireless network supported by the second wireless station.

17. The system as in claim 16, wherein the selected wireless security protocol is the first wireless security protocol, the communication management hardware further operative to:
in response to selection of the first wireless security protocol, establishing a respective wireless communication link between the first wireless station and the second wireless station using the selected first wireless security protocol.

18. The apparatus as in claim 15, wherein the communication management hardware is further operative to:
receive the second protocol information from the second wireless station in response to transmitting the notification; and
wherein the second protocol information indicates a second wireless security protocol different than the first wireless security protocol.

19. The system as in claim 18, wherein the selected wireless security protocol is the second wireless security protocol, the communication management hardware further operative to:
in response to selection of the second wireless security protocol, establish a respective wireless communication link between the first wireless station and the second wireless station using the second wireless security protocol.

20. The system as in claim 15, wherein the second protocol information indicates identities of multiple wireless security protocols supported by the second wireless station, the identities of the multiple wireless security protocols indicating the first wireless security protocol and a second wireless security protocol.

21. The system as in claim 20, wherein the first wireless security protocol corresponds to a first level in a tiered hierarchy of multiple wireless security protocols; and
wherein the second wireless security protocol corresponds to a second level in the tiered hierarchy of multiple wireless security protocols, the second level ranking higher than the first level.

22. The system as in claim 15, wherein the selected wireless security protocol is the first wireless security protocol.

23. The system as in claim 15, wherein the selected wireless security protocol is a second wireless security protocol specified by the second protocol information.

24. The apparatus as in claim 15, wherein the communication management hardware is further operative to:
prior to transmitting the notification, receive a beacon frame from the second wireless station, the beacon frame indicating at least one wireless security protocol supported by the second wireless station.

25. The apparatus as in claim 15, wherein the communication management hardware is further operative to:
prior to transmitting the notification, receive a message from the second wireless station, the message indicating a second wireless communication protocol supported by the second wireless station; and
transmit the notification from the first wireless station to the second wireless station in response to detecting that the second wireless security protocol supported by the second wireless station is different than the first wireless security protocol supported by the first wireless station.

26. The apparatus as in claim 15, wherein the communication management hardware is further operative to:
in response to transmitting the notification, receive a message from the second wireless station indicating that the second wireless station supports the first wireless security protocol; and
in response to detecting that the second wireless station supports the first wireless security protocol as indicated by the received message, establishing a wireless communication link between the first wireless station and the second wireless station using the first wireless security protocol.

27. The apparatus as in claim 15, wherein the communication management hardware is further operative to:
at the first wireless station, receiving a communication from the second wireless station prior to transmitting the notification, the communication indicating an identity of the second wireless station and a second wireless security protocol supported by the second wireless station.

28. The system as in claim 15, wherein the second wireless station is operative to transmit first beacons indicating that the second wireless station supports the first wireless security protocol;
wherein the second wireless station is operative to transmit second beacons indicating that the second wireless station supports a second wireless security protocol, the second wireless security protocol different than the first wireless security protocol; and
wherein a ratio of the first beacons with respect to the second beacons transmitted by the second wireless station is based upon a number of first communication devices wirelessly connected to the second wireless station via the first wireless security protocol versus a number of second communication devices wirelessly connected to the second wireless station via the second wireless security protocol.

29. Computer-readable storage hardware having instructions stored thereon, the instructions, when carried out by computer processor hardware, cause the computer processor hardware to:
retrieve first protocol information assigned to a first wireless station, the first protocol information indicating a first wireless security protocol supported by the first wireless station;
in response to transmitting a notification to a second wireless station indicating an identity of the first wireless security protocol, receive second protocol information communicated from the second wireless station; and
select a wireless security protocol in which to communicate with the second wireless station based on the first protocol information and the second protocol information.
